(19) United States
(12) Patent Application Publication
(10) Pub. No.: US 2007/0108852 A1
(43) Pub. Date: May 17, 2007

(54) METHOD AND DEVICE FOR COOLING OF ELECTRIC MOTORS

(75) Inventor: Ben BOLSOY, Bodo (NO)

Correspondence Address: DENNISON, SCHULTZ & MACDONALD, 1727 KING STREET, SUITE 105, ALEXANDRIA, VA, 22314, US

(73) Assignee: RAPP HYDEMA AS, Bodo (NO)

(21) Appl. No.: 11/565,736

(22) Filed: Dec. 1, 2006

Related U.S. Application Data
(63) Continuation-in-part of application No. PCT/NO04/00162, filed on Jun. 4, 2005.

(51) Int. Cl. H02K 9/00; H02K 1/32

(52) U.S. Cl. 310/58; 310/61

(57) ABSTRACT

Method and apparatus for cooling of electric motors, particularly motors for trawl winches. A tubular motor housing is covered at each end by an end lid with a bearing, for accommodating a rotor which is arranged in a stator with an intermediate tubular interstice between the ends of the motor. Cooling medium is introduced in a void at one end of the motor, for receiving heat from electrical components, and the cooling medium is removed from the motor and circulated through a cooling device. The cooling is made more efficient by pumping the cooling medium through the interstice between the rotor and the stator.

This application is a continuation-in-part of PCT/NO2004/000162 filed Jun. 4, 2004.

### BACKGROUND OF THE INVENTION

The invention relates to a method for cooling of electric motors, and a device for conducting this method. It relates particularly to electric motors for trawl winches.

Trawl winches are traditionally hydraulic powered. Recently, electric motors have been used for this purpose. However prior art electric motor concepts have been space demanding and heavy. One reason for this has been the demand for short time high output at lowering, towing and pulling in, which requires oversized electromagnetic components to avoid overheating. When running slowly, with slow moving motors, air based cooling will be very low.

This has created a need for developing electric motors with reduced dimensions, which can produce a higher output through more efficient cooling.

From EP patent application 919,512 it is known to cool an electric motor without letting the cooling medium contact the electrically active parts. This is achieved by making the motor housing being double walled for circulating cooling liquid through passages in one end cover of the motor. This design is neither economically nor technically satisfactory.

From EP patent specification 402,517 there is known an electric motor with a closed cooling compartment with cooling fins on the stator. Cooling medium is supplied to the cooling compartment and also to the parts of the motor adjoining the cooling compartment. The design of such a cooling compartment requires an extensive intervention in the motor design. This design also will not provide optimal cooling.

### SUMMARY OF THE INVENTION

The main object of the invention is to provide an electric motor with a substantially higher output to meet high output demands without overheating. Thus, it is an object of the invention to provide a motor, particularly for trawl winches, with a cooling system ensuring effective absorption and dissipation of heat energy at its site of generation, where the equipment for cooling is as simple as possible.

It is a further object of the invention to provide a method and a device which can be implemented with the least possible modification of existing motors.

In achieving these objects, it has surprisingly been found that it is possible to achieve efficient cooling by pumping a cooling medium through the interstice between the stator and the rotor of the motor. Thus, a standard electrical motor used according to the invention can provide a substantially higher load.

A number of different liquids may be used as internal liquid and also as external liquid. Liquids may be selected according to the specific use and circumstances. For example, oil and water may be used, respectively, as internal and external cooling liquids.

The invention can be realized particularly simply by pumping the cooling medium in at one end of the motor and providing for an outlet at the other end.

The invention can be realized with a prior art electric motor with a tubular housing, each end of which is covered by a closed end shield with a bearing, for accommodating a rotor arranged in a stator with an intervening tubular magnet slot and with an inlet and an outlet on the electric motor, for a cooling medium circulating through a cooling device with a circulation pump.

To conduct this method, a device can be used in which the interstice serves as a passage for the cooling medium. This may be carried out on a prior art motor without any special adaptation.

Further, it is an advantage if the cooling medium inlet and the cooling medium outlet are at opposite ends of the motor.

This will be particularly advantageous if at least one of the cooling medium inlet and outlet is arranged at the end shield of the motor. This achieves a particularly simple cooling system, with low investment. Further, a surprisingly efficient heat transfer is obtained.

It is also possible to adapt the invention to existing, installed motors, as the cooling system can be added with simple modifications.

### BRIEF DESCRIPTION OF THE DRAWINGS

The invention is described further below with reference to the drawings, in which:

FIG. 1 shows schematically a cooling system according to the invention; and

FIG. 2 shows a section through a prior art motor used with the cooling system of the invention.

### DESCRIPTION OF THE PREFERRED EMBODIMENTS

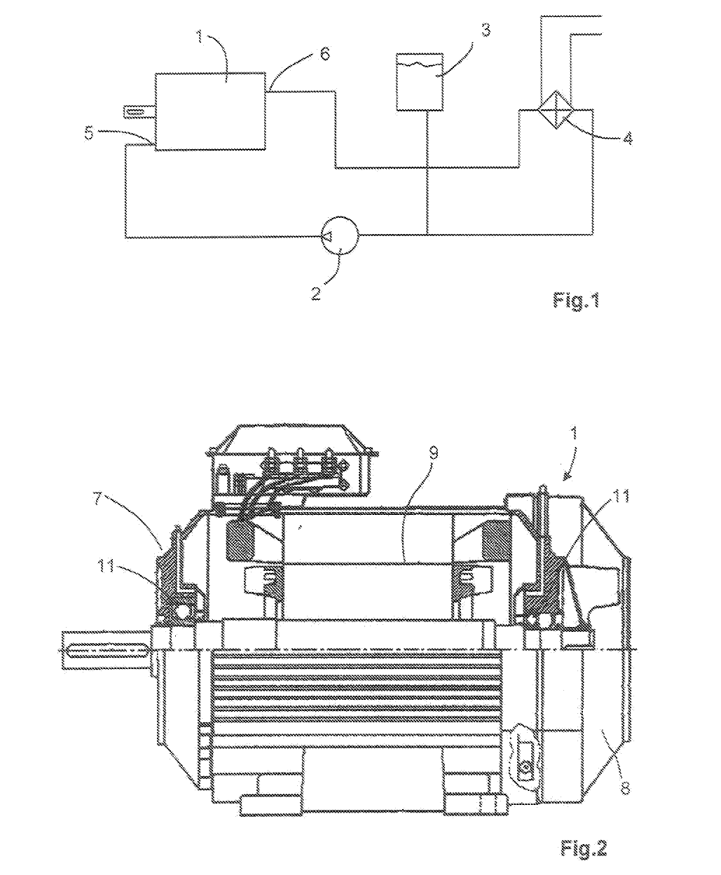

FIG. 1 shows a cooling system according to the invention. It is connected to a motor 1 which is supplied with a cooling medium at an inlet 5 at one end of the motor and where the cooling medium is withdrawn at an outlet 6 at the other end. From the outlet, the cooling medium is circulated in a circuit with a fluid-to-fluid heat exchanger 4, powered by a circulation pump 2. A tank 3 with cooling medium provides sufficient supply of cooling medium.

FIG. 2 shows a prior art DIN-standardized electric motor 1 which has two closed end shields or covers 7 and 8. Such motors will always have an interstice 9 which is open towards the cavities inside the end covers. FIG. 2 also shows two bearings 11 arranged in the end covers. Cooling medium which is supplied through an inlet in end cover 7 flows through the interstice 9 before leaving through an outlet in the opposite end cover 8.

In all electric motors, the heat generated is a limiting factor to the output. By cooling according to the invention, the dimensional criteria for the load is changed, thereby allowing higher loads for a certain size of the motor. This allows the use of smaller and lighter motors for certain purposes, e.g. operation of trawl winches, than previously possible. This will be of particular advantage when such winches are to be sized for towing when used for trawling, with low or zero rotation, but a high torque load.

Such use of a liquid cooling medium, circulated directly through the inner part of the electric motor, will also mean better protection against corrosion from saline air and sea water when operated in such environments.

What is claimed is:

1. Method for cooling an electric motor, including a tubular motor housing covered at each end by an end shield with a bearing, for accommodating a rotor which is arranged in a stator with an intermediate tubular magnetic slot connecting the ends of the motor,
comprising introducing cooling medium in a void at one end of the motor, for transfer of heat from electrical components to the cooling medium,
removing the cooling medium to which heat has been transferred from the motor, and
circulating the removed cooling medium through a cooling device to remove the heat therefrom,
wherein the cooling medium is circulated through an interstice between the rotor and the stator.

2. Method according to claim 1, wherein the cooling medium is supplied at one end of the motor and withdrawn from an opposite end.

3. Method according to claim 1, wherein the motor is a motor for a trawl winch.

4. In combination, an electric motor and a device for cooling the electric motor, comprising a tubular motor housing which at each end is covered with a closed end lid with a bearing, for accommodating of a rotor arranged in a stator with an intermediate tubular interstice, an inlet on the electric motor for introducing a cooling medium, an outlet on the electric motor for removing the cooling medium, means for introducing the cooling medium into the interstice between the stator and rotor with the interstice acting as a duct for the flow of the cooling medium between the inlet and the outlet, a cooling device for cooling the cooling medium removed from the motor, and a circulation pump for circulating the cooling medium.

5. Combination according to claim 4, wherein the cooling medium inlet and the cooling medium outlet are arranged at opposite ends of the electric motor.

6. Combination according to claim 4, wherein at least one of the cooling medium inlet and outlet is arranged on an end lid of the electric motor.

7. Combination according to claim 4, wherein the motor is a motor for a trawl winch.
